(19) United States
(12) Patent Application Publication
(10) Pub. No.: US 2012/0074089 A1
(43) Pub. Date: Mar. 29, 2012

(54) TELESCOPIC SECTION AND CRANE WITH A TELESCOPIC SECTION

(75) Inventors: HANS-DIETER WILLIM, Ulm-Unterweiler (DE); ENGELBERT HÄBE, Ehingen (DE); Joachim Henkel, Holzgunz (DE)

(73) Assignee: Liebherr-Werk Ehingen GmbH, Ehingen (DE)

(21) Appl. No.: 13/239,626

(22) Filed: Sep. 22, 2011

(30) Foreign Application Priority Data
Sep. 23, 2010 (DE) UM202010013544.3

(51) Int. Cl. B66C 23/687

(52) U.S. Cl. 212/348

(57) ABSTRACT

The present invention relates to a telescopic section comprising a section tube having at least two bolt parts each having a cut-out, wherein at least one common bolt sheet is provided on or in the profile tube for reinforcing at least two bolt points.

### BACKGROUND OF THE INVENTION

The invention relates to a telescopic section in accordance with the preamble of claim 1 and to a crane having a telescopic boom.

Telescopic sections are used in cranes having telescopic booms. They usually comprise section tubes which are bolted to one another after the extension. To configure the extension length variably, each telescopic section has a plurality of bolt points as a rule. Three possible bolt points per telescopic section are frequently provided, for example.

The counter-bolt points are always located in the region of the end piece of a telescopic section. The sliding pieces for the support points are likewise held at this end piece. High support forces are consequently transmitted in the radial direction in this region. The highly loaded bolt point therefore requires a reinforcement with respect to the remaining sheet metal in the telescopic section.

A possible reinforced embodiment takes place by a further sheet metal layer which is applied in the region of the bolt point. This additional sheet metal layer is usually called a bolt plate or a locking plate.

A proposal for the reinforcement of the bolt points provides that the bolt plate or locking plate is welded to the section tube at the bolt point. The welding process itself is particularly complex and has to be carried out by trained specialists. The base material of the telescopic section is equally strained by the welding process.

The use of fine grain steel with a yield point of a maximum of 960 N/mm² to 1100 N/mm² is usual in the region of the telescopic section. There is currently no licensed filler metal having a higher yield point than the stated 1100 N/mm² for a fine grain constructional steel with higher yield points. If a base material having a substantially higher yield point is used for manufacturing the telescopic section, the weld seam with the less loadable additional filler metal is the weakest link in the construction.

### SUMMARY OF THE INVENTION

It is therefore the object of the invention to provide a generic telescopic section with a bolt point which is simple to apply and which is more stable from a construction aspect.

This object is achieved in accordance with the invention by the features herein.

In accordance with this solution, a telescopic section, which comprises a section tube having at least two bolt points each having a cut-out, is provided with at least one common bolt sheet for reinforcing at least two volt points. The common bolt sheet is attached in the region of the bolt points on or in the section tube.

Unlike the already known solutions, not every bolt point is accordingly individually provided with a separate reinforcement, but rather instead a common bolt sheet is provided which reinforces at least two bolt points.

All bolt points of a telescopic section are preferably made reinforced by the common bolt sheet.

The common bolt sheet provides a smooth transfer of the forces acting on the telescopic section, in particular on the bolt points, and therefore allows an optimized force flow in the telescopic section.

The section tube preferably comprises two mutually connected half-shells. The section tube preferably comprises an upper shell (upper web) primarily loaded by tension and a lower shell (lower web) primarily loaded by compression. In accordance with the invention, at least one common bolt sheet is arranged on or in such a section tube for reinforcing the bolt points. Under these conditions, the common bolt sheet can be attached on or in one of the half-shells before the putting together of the half-shells. The access to the fastening point is hereby possible at both sides.

A telescopic section is provided by the present invention which allows the use of fine grain steel as a base material having very high yield points. The attaching of a common bolt sheet allows a sufficiently high number of stress cycles.

The common bolt sheet is advantageously arranged on or in the upper web of the section tube or alternatively on or in the side wall or walls of the section tube.

At least one common bolt plate in particular extends over the total length of the telescopic section. Alternatively, it is often sufficient to limit the bolt sheet to the region of the bolt points at the telescopic section.

In a preferred embodiment of the invention, the common bolt sheet is composed of different metal plates. The number of bolt plates of the common bolt sheet preferably corresponds to the number of bolt points. The bolt plates are connected to one another via one or more force guiding plates. In simplified terms, two respective bolt plates are mutually connected via one force guiding plate.

This measure optimizes the smooth transfer of the forces acting on the telescopic section, in particular of the forces acting on the bolt points, and allows a further improved force flow in the telescopic section. It must be noted that various forces can be superimposed on one another specifically in the upper web of the telescopic section. The tension caused at this point by load and inherent weight, the compression introduced into the bolt point by the bolts and the radially aligned support forces introduced by the support points into the surrounding telescopic section can be named by way of example here.

The individual metal sheets comprising the common bolt sheet, in particular the bolt plates and force guiding plates, are put together by means of a weld connection. The common bolt sheet is prefabricated from the metal sheets and is consequently welded under ideal conditions. The check of the weld seams, in particular cross-seams, is hereby simplified and can be carried out before the final assembly on the section tube.

A substantial advantage of the production process of the pre-welded common bolt sheet is that the cross-seams are accessible from both sides. This ensures an ideal and especially loadable weld connection.

The common weld sheet is preferably welded onto the section tube of the telescopic section or is welded into it. The common bolt sheet is, as already stated above, preferably prefabricated and can subsequently be welded onto or into the section tube. If the bolt sheet is welded into the section tube, the section tube consequently comprises the lower sheet, the two halves of the upper web and the bolt sheet between the two halves of the upper web. The bolt sheet can equally be welded into at least one side wall of the section tube.

In the case of a division of the telescopic section tube in the upper web and the lower web, it is expedient to weld the common bolt sheet onto the upper web to establish the connection between the upper web and the lower web. The sliding joints between the bolt sheet and the section tube are more easily accessible for assembly in this case, which allows an increase in quality of the welding process. This is in particular of importance for the resulting stability of the section tube since most bolt forces are removed from the common bolt sheet via these sliding joints.

All types of sheet metal of the common bolt sheet are preferably connected, in particular welded, to the telescopic section. For example, the force guiding sheets and all bolt plates are welded to the section tube.

The weld connection between the bolt plate and the upper web of the section tube in particular takes place at both sides. This is only possible when the lower side of the upper web is accessible during the assembly of the bolt sheet, i.e. the lower web has not yet been mounted.

All metal sheets, for example the upper web, the lower web and the metal sheets of the bolt sheet, are designed with different sheet thicknesses which are especially matched to the respective load. All metal sheets are advantageously mutually connected by means of weld seams.

The different sheet thicknesses can preferably be manufactured by machining.

The common bolt sheet advantageously has a wavy side edge extent. The side edges preferably converge in the region of the force guiding plates between two bolt plates.

Alternatively, an embodiment of the common bolt sheet with a straight-line edge extent is conceivable. An almost rectangular shape of the bolt sheet has proved to be advantageous.

The invention furthermore relates to a bolt sheet for a telescopic section in accordance with one of the above advantageous embodiments.

Furthermore, the invention relates to a crane having a telescopic boom which includes at least one telescopic section in accordance with one of the preceding embodiments. The crane obviously has identical advantages and properties to the telescopic section in accordance with the invention so that a repeat explanation at this point is dispensed with.

### BRIEF DESCRIPTION OF THE DRAWINGS

Further details and advantages of the invention will be explained in more detail with reference to the embodiments shown in the drawings. There are shown:

FIG. 1: a side view of a telescopic crane boom;

FIG. 2: the telescopic boom section in accordance with the present invention;

FIG. 3: a plan view of the assembled common bolt sheet;

FIG. 4: an assembled telescopic section in accordance with the present invention;

FIG. 5: a cross-sectional representation along the lines C-C in FIG. 4;

FIG. 6: cross-sectional representations along the lines A-A, D-D and E-E of FIG. 4; and

FIG. 7: a sketch of a possible alternative embodiment of the telescopic section in accordance with the invention.

### DESCRIPTION OF THE PREFERRED EMBODIMENTS

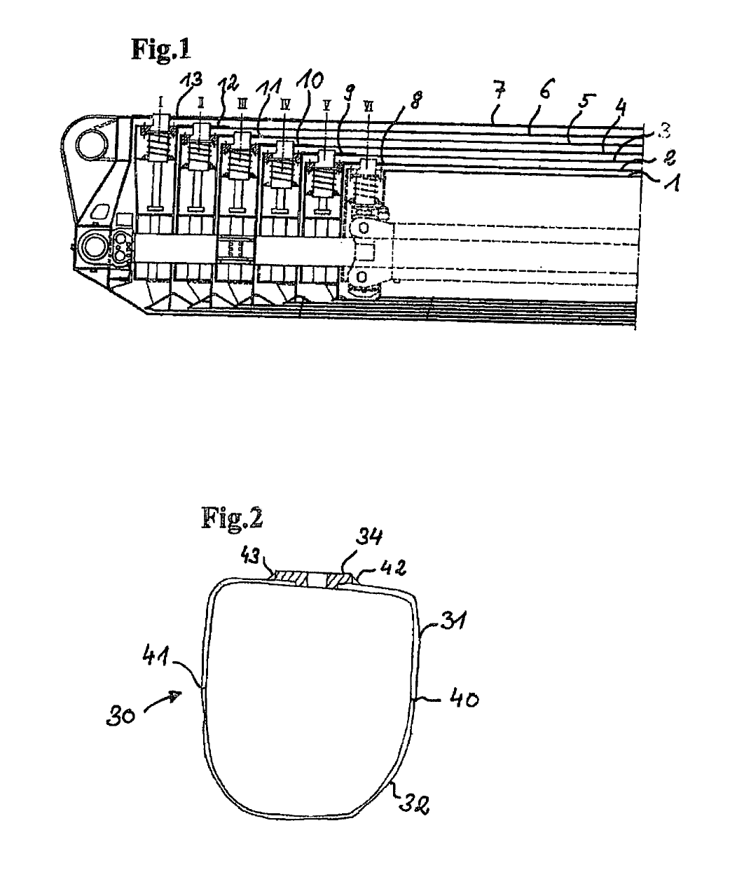

FIG. 1 shows a side view of a telescopic boom which comprises a plurality of telescopic sections 1-7 which can be telescoped. The individual telescopic sections can be extended into a desired position and can be fixed with the aid of bolting apparatus I-VI. The desired extension position can be varied via the selection of the corresponding bolt point of a telescopic section. For this reason, precisely three bolt points 8-13 are as a rule provided per telescopic section.

FIG. 2 shows a cross-section through the tube section of a telescopic section in accordance with the invention. The section of the telescopic section part is formed from two half-shells, namely the upper shell 31 primarily tensioned, also known as the upper web, and the lower shell 32 primarily compressed, also called the lower web. At least one common bolt sheet 34 is welded onto this telescopic tube 30. In accordance with FIG. 2, the common bolt sheet 34 is attached to the upper web 31 of the telescopic boom tube 30, in particular while forming the sliding joints 42, 43.

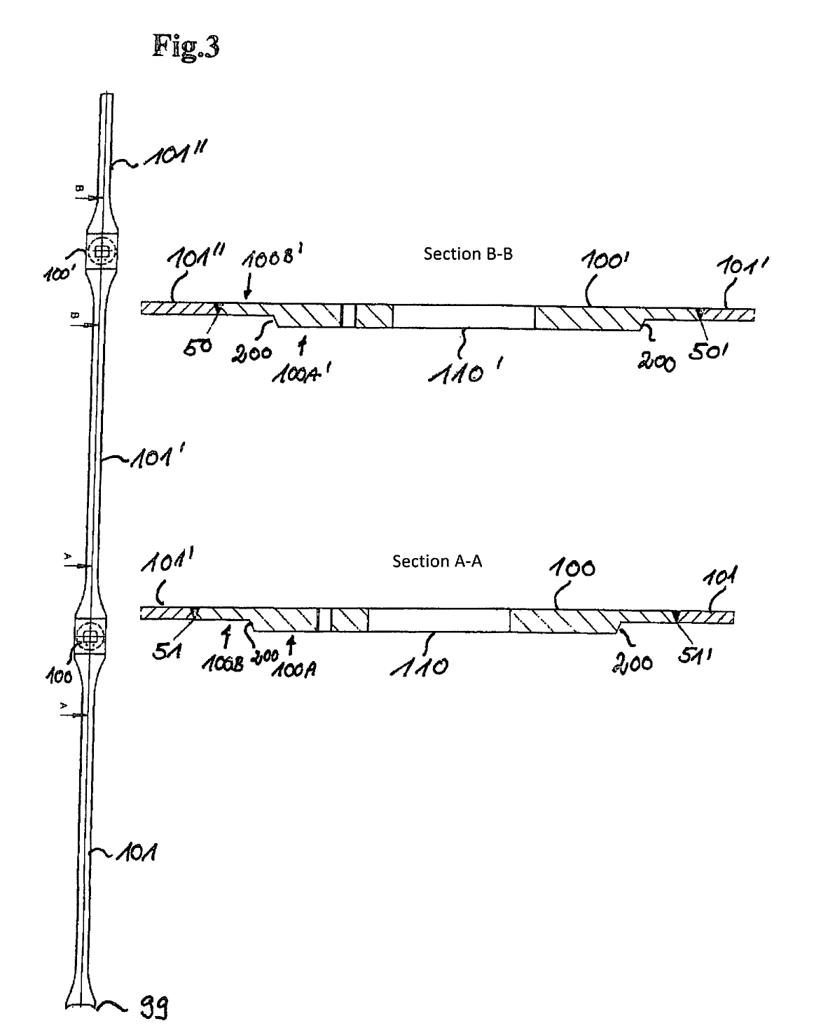

Before the mounting of the bolt sheet 34 onto the section tube 30, it is completely put together from different metal sheets. A completely assembled bolt sheet 34 can be seen from FIG. 3. It comprises the actual bolt plates 100, 100′ and the force guiding plates 101, 101′, 101″ which act as connection members between two respective bolt plates 100, 100′.

The common bolt sheet 34 is prefabricated from the metal sheets 100, 100′, 101, 101′, 101″ and can thus be welded under ideal conditions. The accessibility to specific regions of the bolt sheet 34 is in particular hereby simplified so that the weld seams, in particular the cross-seams, can equally be sufficiently examined. A very substantial advantage in the production process of the prewelded common bolt sheet 34 is that the cross-seams are accessible from both sides so that an ideal weld connection can be achieved.

Two sectional representations of the two longitudinal sections along the lines A-A and B-B can furthermore be seen from FIG. 3. Both images show a longitudinal section through the bolt plates 100, 100′. The bolt plates 100, 100′ each have a recess 110, 110′ through which a bolt, not shown in any more detail here, can be pushed to establish a bolt connection. The transition between the bolt plates 100, 100′ to the respective adjacent force guiding plates 101, 101′ 101″ is marked by the weld connection points 50, 50′, 51, 51′. Since the common bolt sheet 34 is completely put together before the mounting onto the section tube 30, the access to the corresponding weld connections 50, 50′, 51, 51′ is particularly simple, whereby a qualitative increase in the welded cross-seam to be achieved can be achieved. The access to the cross-seam is in particular possible from the upper side and from the lower side of the bolt sheet 34. The welded cross-seam is equalized by a suitable process.

The 0% bolt plate, that is the bolt plate 99 disposed at the end side is not prefabricated with the bolt sheet 34, but is rather welded directly on the section tube 30 of the telescopic section due to production tolerances.

The bolt plates 100, 100′ themselves can have different sheet thicknesses 100A, 100A′, 100B, 100B′. The sheet thickness is reduced by means of machining. The transitions 200 between the different sheet thicknesses 100A, 100B, 100A′, 100B′ are adapted to optimize the force flow. Geometric notches are avoided.

The force guiding plates 101, 101′, 101″ have a wavy side edge extent. The side edges of a force guiding plate which extend in parallel converge in the region between two bolt plates 100, 100′ and open in the adjoining bolt plate 99, 100, 100′.

The mounting on or in the section tube 30 takes place after the completion of the bolt sheet 34. The bolt sheet 34 can be arranged either on the upper web 31 or on a side wall of the section tube. Alternatively, the bolt sheet 34 can also be welded into the upper web or at least into a side wall.

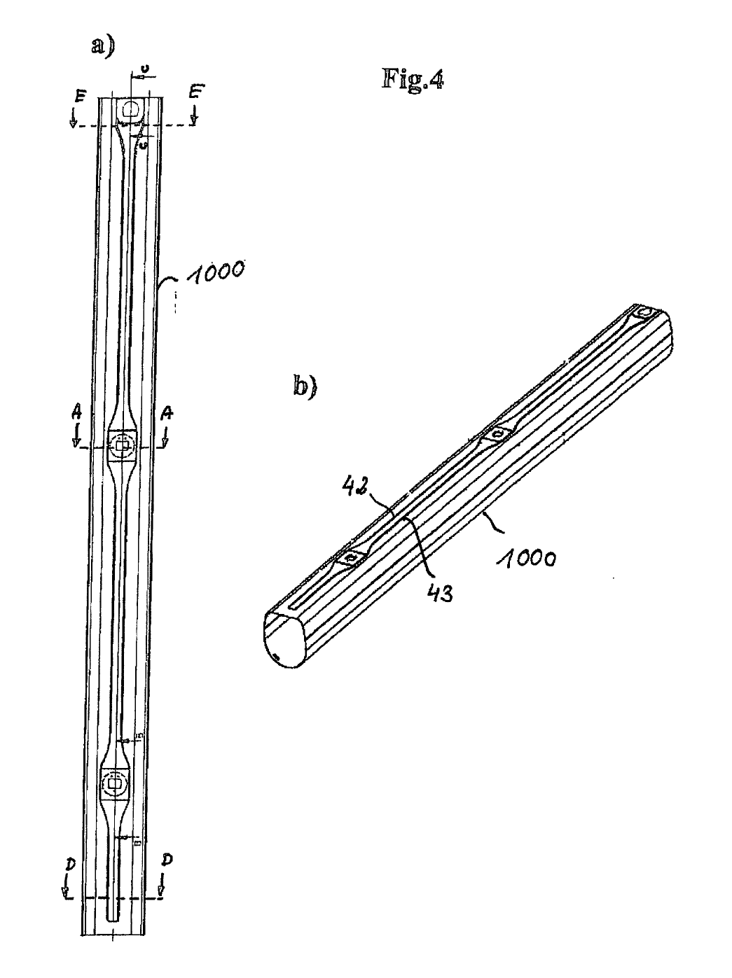

A possible embodiment of a completely assembled telescopic section 1000 can be seen from the FIGS. 4a and 4b in a plan view (4a) and in a perspective side view (4b). For assembly, the complete sheet strip of the bolt sheet 34 is welded onto the upper web 31 which has not yet been connected to the lower web 32 up to this point. The sliding joints 42, 43 can hereby be manufactured in an ideal quality. Most bolt forces are removed from the common bolt sheet 34 via these sliding joints 42, 43.

The bolt plate 100, 100′ itself is likewise connected to the upper web 31. Since the lower side of the upper web 31 has still been accessible up to now, the welding process for connecting the bolt sheet 34, in particular the bolt plate 100, 100′, to the upper web 31 can take place at both sides.

All sheets, that is the lower shell 23, the upper shell 31 and the sheets 100, 100′, 101, 101′, 101″, are mutually connected via the weld seams 40, 41, 42, 43, 50, 50′, 51, 51′. The sheet thicknesses of the individual sheets are made differently and are especially designed for the respective loads in the corresponding sheet section. While the weld seams 40, 41 which connect the upper shell 31 and the lower shell 32 to one another are made in a known manner, the weld seams 42, 43 can also not extend in a straight line and follow the bolt sheet 34.

The common bolt sheet 34 provides a smooth transition of the forces and an optimized force flow in the telescopic section 1000. It must be noted that various forces can be superimposed on one another in the upper web 31. The tension caused by the load and the inherent weight, the compression introduced into the bolt point by the bolts I-VI and the radially aligned support force introduced into the surrounding telescopic section by the support points can be named here.

Since the common bolt sheet 34 is less necessary as bracing, it does not necessarily have to extend over the whole length of the telescopic section. For reasons of weight, the common bolt sheet 34 can also only be limited to the region of the telescopic section which bears the corresponding bolt points. The minimum dimension of the common bolt sheet 34 is, however, to be dimensioned in every case so that at least two bolt points can be connected to one another.

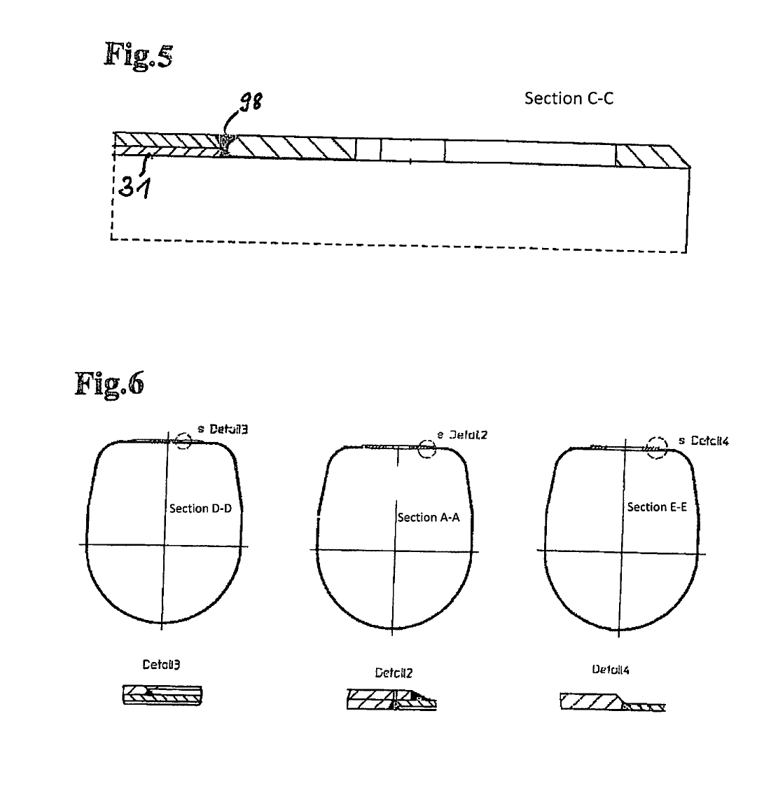

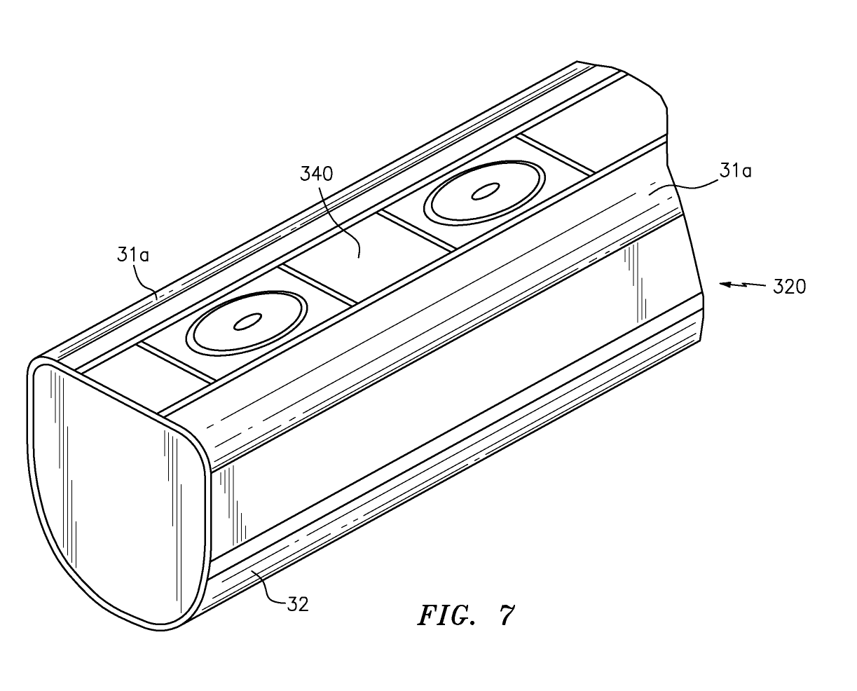

FIGS. 5 and 6 show sectional representations in accordance with the lines A-A, C-C, D-D and E-E. Especially FIG. 5 shows the fastening of the 0% bolt plate 99 to the section tube 30 of the telescopic section. The latter is, as already initially explained, not first assembled with the bolt sheet 34, but is rather instead welded separately on the section tube 30. The corresponding connection weld seams 98 can be seen from FIG. 5.

FIG. 6 furthermore shows three cross-sections along the lines A-A, D-D and E-E through the telescopic section of FIGS. 4a and 4b. The individual detail representations shown of the cross-section drawings mark the extent of the different weld seams for fastening the bolt sheet 34 on the upper web 31 of the telescopic section.

An alternative solution approach for the design of the common bolt sheet 340 can be seen from FIG. 7. Instead of the wavy side edge extent of the embodiment of FIGS. 2 to 6, they are made straight in the embodiment of FIG. 7. The embodiment in accordance with FIG. 7 accordingly comprises a throughgoing sheet strip 340. The bolt sheet is furthermore not welded on, but rather welded into the section tube 30. The latter consequently comprises the lower shell 32, the two halves 31a, 31b of the upper web 31 which are mutually connected by welding into the bolt sheet 340.

The bolt sheet 340 can naturally instead be welded in or on at any desired point of the section tube 30, in particular into at least one side wall.

1. A telescopic section comprising a section tube having at least two bolt points each having a cut-out, wherein
at least one common bolt sheet is arranged on or in the section tube for reinforcing at least two bolt points.

2. A telescopic section in accordance with claim 1, wherein the bolt points are arranged on the upper web of the section tube and the common bolt sheet is likewise arranged on or in the upper web.

3. A telescopic section in accordance with claim 1, wherein the bolt points are arranged on the side wall or walls of the section tube and the common bolt sheet is likewise arranged on or in the side wall or walls.

4. A telescopic section in accordance with claim 1, wherein the bolt sheet extends completely over the total telescopic section length or only covers the region about at least two bolt points.

5. A telescopic section in accordance with claim 1, wherein the common bolt sheet is composed of different sheets, in particular of bolt plates and force-guiding plates.

6. A telescopic section in accordance with claim 1, wherein the common bolt sheet is welded on or in the section tube and/or the common bolt sheet is composed of different metal sheets by welding processes.

7. A telescopic section in accordance with claim 1, wherein the bolt sheet has different sheet thicknesses, in particular the bolt plate or plates have different sheet thicknesses.

8. A telescopic section in accordance with claim 7, wherein the different sheet thicknesses can be manufactured by machining.

9. A telescopic section in accordance with claim 1, wherein the common bolt sheet has wavy side edges.

10. A telescopic section in accordance with claim 1, the common bolt sheet has straight side edges, with the bolt sheet preferably being made rectangular.

11. A bolt sheet for a telescopic section in accordance with claim 1.

12. A crane having a telescopic boom, wherein at least one telescopic section of the boom is made in accordance with claim 1.

13. A telescopic section in accordance with claim 3, wherein the bolt sheet extends completely over the total telescopic section length or only covers the region about at least two bolt points.

14. A telescopic section in accordance with claim 2, wherein the bolt sheet extends completely over the total telescopic section length or only covers the region about at least two bolt points.

15. A telescopic section in accordance with claim 14, wherein the common bolt sheet is composed of different sheets, in particular of bolt plates and force-guiding plates.

16. A telescopic section in accordance with claim 13, wherein the common bolt sheet is composed of different sheets, in particular of bolt plates and force-guiding plates.

17. A telescopic section in accordance with claim 4, wherein the common bolt sheet is composed of different sheets, in particular of bolt plates and force-guiding plates.

18. A telescopic section in accordance with claim 3, wherein the common bolt sheet is composed of different sheets, in particular of bolt plates and force-guiding plates.

19. A telescopic section in accordance with claim 2, wherein the common bolt sheet is composed of different sheets, in particular of bolt plates and force-guiding plates.

20. A telescopic section in accordance with claim 5, wherein the common bolt sheet is welded on or in the section tube and/or the common bolt sheet is composed of different metal sheets by welding processes.
